(19) United States
(12) Patent Application Publication
(10) Pub. No.: US 2002/0138450 A1
(43) Pub. Date: Sep. 26, 2002

(54) Electronic payment method and device

(76) Inventor: Gilles Kremer, Vanves (FR)

Correspondence Address: YOUNG & THOMPSON, 745 SOUTH 23RD STREET 2ND FLOOR, ARLINGTON, VA, 22202

(21) Appl. No.: 10/018,371

(22) PCT Filed: Apr. 19, 2001
(86) PCT No.: PCT/FR01/01205

(30) Foreign Application Priority Data
Apr. 19, 2000 (FR) 00/05025
Oct. 4, 2000 (FR) 00/13101
Nov. 24, 2000 (FR) 00/15215

(51) Int. Cl. G06F 17/60

(52) U.S. Cl. 705/75

(57) ABSTRACT

The present invention relates to a process and device for electronic payment which comprises an operation of opening a communication session between a first user terminal and a merchant server, on a first communication support, such as the Internet.

During said communication session, the user terminal constitutes a single use payment certificate. The user receives, on a second terminal, such as a mobile phone, confidential information such as a password and transmits it to the first support. The correspondence between the information transmitted to the second terminal and that transmitted by the first terminal is verified and if there is correspondence the payment is validated.

The present invention relates to a process and a device for electronic payment.

The Internet sites which provide materials or services for pay often require payment by payment card. However, the users know that if the number of their payment card is copied with the expiration date, payments can be made from the account attached to this card without their agreement. These users are thus very hesitant about using a payment means that is so poorly protected.

For their part, the merchant sites know that the clients can cancel or “repudiate” the payments made with the payment cards because they do not sign for the payment.

Because of its open nature, the Internet has increased the need for security of data transmission. Thus, the architecture itself of the Internet renders it particularly vulnerable: the IP protocol, totally decentralized, causes datagrams or “packets” to circulate without being protected. The IP addresses themselves, managed by the DNS (Domain Name Servers), are not protected from malicious activities. The systems of use have security defects. The following is an impressive list of dangers:

listening to packets or “sniffing”;

substitution of packets or “spoofing”;

pirating DNS;

denial of service;

intrusions; and

dissemination of malicious programs, viruses and Trojan horses.

Each of the aspects of the present invention seeks Lo overcome certain of these drawbacks. To this end, the present invention proposes carrying out a payment on a first communication network by using a single use number of payment means, transmitted or validated by using a second communication network, preferably secured and comprising unique terminal addresses, for example a network of mobile telephone, two communication sessions being simultaneously open on the two communication networks. Thus, even if this payment means is copied, the copy is unusable, because the payment means is a single usage one, which is to say that it cannot be used twice. Moreover, the payment means cannot be stolen without having simultaneously two terminals simultaneously connected to the two communication networks.

According to one aspect, the present invention envisages a process for payment comprising an operation of opening a communication session between a first user terminal and a merchant site server, on a first communication support, characterized in that it comprises, during said communication session:

an operation of transmission by the user terminal of information identifying the user,

an operation of transmitting to a payment server of information identifying the user,

an operation of constituting by said user terminal a single use payment certificate,

an operation of transmitting by the payment server confidential information to a second user terminal, by means of a second communication support on which each address is attributed to at most one user terminal,

an operation of transmission by the first terminal of said confidential information;

an operation of verifying, by the payment server, of the correspondence of the confidential information received from the first terminal on the first communication network, with the confidential information transmitted to the second user terminal, and

in case of correspondence, an operation of validation of the payment.

According to one aspect of the present invention, the payment is carried out by means of a communication session with a payment server on the first communication network, during which session the second communication network is used to authenticate the payer by transmitting to him confidential information on the second network, which he retransmits on the first network. In case of authentication, the payment server transmits payment information to the payee so that the transaction can be carried out.

The inventor has determined that there is need both to authenticate a client who carries out a payment, and to permit him not to transmit the number of a payment card, whilst using known means to pay by any payment means. Thus, this avoids modifying the systems used by the sites, whilst guaranteeing to them authentication of the clients and security of the payment means.

According to one aspect of the present invention, during a communication session between a payer (client) and a payee (business person or merchant) the payment is carried out by transmitting on the second communication network with a single address, a payment means number which the user transmits to the payee and which the payee uses to obtain payment, in the same way as an embossed payment card number.

In this embodiment, the simultaneity of the communication session between the user terminal and the server of the merchant's site, on the first communication network and the payment operations, ensures protection of increased security because the session on the first network cannot be modified by third persons.

In particular embodiments, the single usage payment means is transmitted to the client, then the client is authenticated to validate the use of the single use payment means.

In particular embodiments, the client is authenticated and then a single usage payment means is transmitted to him.

In particular embodiments, the use of the single usage payment means authenticates the client.

In each of these embodiments, the client is protected, because the single usage payment means cannot be reused by third persons, connected to the bank account or the credit of the client. The site is also protected, because the payment is signed, thus the client is authenticated definitively and he cannot repudiate the payment.

It should be noted that the term “single usage payment means” covers the case in which a number is taken, for example arbitrarily, from a group of numbers of payment means reserved for the practice of the present process. This term also covers the case in which the payment means can be reused for a predetermined number of payments, until a predetermined amount or for a predetermined period. However, preferably, the single use payment means can serve only for a transaction corresponding to one communication session in progress between the user terminal and the merchant's site server.

In a particular embodiment, each single use payment means is displayed on a screen of the Internet access terminal. The present invention envisages a graphic interface of payment which comprises the display of a single use payment means whose user is authenticated to validate the use of this payment means.

The present invention also envisages a single use payment means with which is associated an authentication carried out according to the means set forth in French patent application 97 13825 filed Nov. 4, 1997. Briefly stated, these means comprise the transmission of confidential information on a communication support, typically a telephone network or the wireless transmission of alphanumerical messages, the acquisition of this confidential information by the user on the Internet access terminal and the transmission of the confidential information by Internet to authenticate the user.

The present invention also envisages solving the problem of the multiplication of encryption keys and the risks which flow therefrom. In cryptology, a key is inserted at the time of encoding the data so as to ensure the confidentiality thereof. The different available security standards, for an electronic courier, for communication sessions on the Web (SSL or Secure Socket Layer) for the IP protocol itself (IPsec), use a whole arsenal of modern methods: authentication of signature, exchange of conventional key, symmetric encoding. Hundreds of millions of RSA keys have thus been produced.

There thus arise new problems: how to manage these keys? As was noted by Jacques Stern, Director of the Computer Department of the Upper Teachers College “it is an illusion to use RSA encoding while dragging around his secret keys on a hard disk that is poorly protected against intrusion” (in an article published in “Le Monde” dated Sep. 12, 2000). Also the question arises of connecting a public RSA key to its legitimate proprietor.

The present invention envisages, according to one aspect, a process of certification, characterized in that it comprises:

an operation of data transmission from an emitter computer system to a receiving computer system, on a first communication support,

an operation of generating a track of said data representative of said data, for the receiving computer system,

an operation of transmission of a portion of said track to a communication device, on a second communication support different from the first communication support,

an operation of receiving said portion of the track by the emitter computer system,

an operation of transmission of said track portion from the emitter computer system to the receiver computer system, and

an operation of verifying the correspondence of the track portion received by the receiving computer system with the track generated by the receiving computer system.

Thanks to these arrangements, the track portion is connected to said data and can serve to detect an ultimate modification of said data.

According to particular characteristics of the process as briefly set forth above, said track is representative of a hash of said data. Thanks to these arrangements, the trace portion permits detecting any future modification of said data.

According to particular characteristics, the process as briefly set forth above comprises an operation of transmitting an identification of a user of the emitter computer system. Thanks to these arrangements, an authentication of the user of the emitter computer system or an electronic signature can be carried out.

According to particular characteristics, the process as briefly set forth above comprises an operation of placing into correspondence said identifier with an address of the communication device on the second communication support. Thanks to these arrangements, the address of the communication device is an address which corresponds to the user of the emitter computer system.

According to particular characteristics of the process as briefly set forth above, said track is representative of a private key reserved by the receiver computer system. Thanks to these arrangements, the receiver computer system carries out a signature of said data.

According to particular characteristics, the process as briefly set forth above comprises an operation of placing into correspondence said identifier with said private key. Thanks to these arrangements, the receiver computer system carries out a signature of said data in the name of the user of the emitter computer system.

According to particular characteristics, the process as briefly set forth above comprises an operation of truncating said track, and in that in the course of the operation of transmission of at least a part of said track, the result of said truncation is transmitted. Thanks to these arrangements, the portion of said track comprises fewer symbols than said track.

According to particular characteristics of the process as briefly set forth above, the first communication support is the Internet. Thanks to these arrangements, the data can be transmitted from any data system connected to the Internet.

According to particular characteristics of the process as briefly set forth above, the second communication support is a wireless network. Thanks to these arrangements, the authentication of the user of the emitter computer system can be carried out anywhere.

According to particular characteristics of the process as briefly set forth above, in the course of the transmission operation of said data, an identifier of a destination computer system is transmitted, said process comprising an operation of transmission of said data from the receiving computer system to a destination computer system. Thanks to these arrangements, the receiving computer system can serve as an intermediate in the transmission between the emitter computer system and the destination computer system. It can moreover ensure the operations of dating, notarization or certification of receipt by the destination, of said data.

According to particular characteristics, the process as briefly set forth above comprises an operation of using said data with a public key and in that in the course of the transmission operation of said data to said destination computer system, said public key is transmitted. Thanks to these arrangements, the destination of said data can verify the identity of the emitter of said data, by the use of the public key.

According to particular characteristics, the process as briefly set forth above comprises an operation of generating confidential information by the receiver computer system and an operation of transmitting to a second communication device confidential information to a communication device on the second communication support, by the receiver computer system, a reception operation of said confidential information by the receiving computer system, on the first communication means and an operation of verification of the correspondence between the confidential information transmitted by the receiving computer system with the confidential information received by the receiving computer system.

Thanks to these arrangements, the destination of said data is authenticated.

The present invention also envisages a certification device, characterized in that it comprises:

a transmission means for data from an emitter computer system to a receiver computer system, on a first communication support,

a means for generating a track of said data representative of said data, by the receiving computer system,

a means for transmitting at least a portion of said track to a communication device, on a second communication support different from the first communication support,

a means for receiving said track by the emitter computer system,

a means for transmitting said track from the emitter computer system to the receiver computer system, and

a means for verifying the correspondence of the track received by the receiver computer system and the track generated by the receiver computer system.

The particular characteristics and advantages of said device correspond to the particular characteristics and advantages of the process as briefly set forth above.

The present invention envisages, according to one aspect, a certification process, characterized in that it comprises:

an operation for receiving a disposable certificate;

an operation of encoding data with said disposable certificate;

an operation of transmission of the encoded data;

an operation of signature of the transmission of said data; and

an operation of revocation of said disposable certificate.

According to one aspect, the present invention envisages a certification process, characterized in that it comprises:

a first operation of signature of data by a device for supplying said data without a private key of the user who supplies said data; and

a second operation of signature of data which substitutes for the first signature, a second signature using a private key of said user.

According to one aspect, the present invention envisages a process for the transmission of data, characterized in that it comprises:

an operation of transmission of said data from a first computer system to a second computer system;

an operation of generation of a seal or hash representative of said data, from said data;

an operation of transmitting said seal or hash by said second computer system;

an operation of authenticating the emitter of said data using said seal or hash; and

an operation of verifying said seal or hash.

Thanks to each of these aspects, the keys, seals, hashes or certificates are not stored on a user terminal, which protects them against any risk of theft or copying. Moreover, the certification can thus be independent of the terminal used by the signatory, which renders the signature portable from one system to another.

According to particular characteristics of each of the aspects of the present invention, in the course of the operation of generating the disposable certificate, a privileged key is generated. Thanks to these arrangements, the disposal certificate has the same safety characteristics as a private key.

According to particular characteristics of each of the aspects of the present invention, in the course of the encoding operation, a track of data to be transmitted is determined in a form known by the name of the hash. Thanks to these arrangements, any modification of the data to be transmitted after the generation of this hash is detectable by use of the hash.

According to particular characteristics of each of the aspects of the present invention, in the course of the encoding operation, there is used an applicative routine that is preliminarily telecharged. Thanks to these arrangements, the transmission of the data to be transmitted is protected by said routine.

According to particular characteristics of each of the aspects of the present invention, in the course of the operation of transmission of the encoded data, the data to be transmitted are also transmitted. Thanks to these arrangements, any modification of the data to be transmitted can be detected by using the encoded data.

According to particular characteristics of each of the aspects of the present invention, in the course of the signature operation, a secret seal is transmitted to a receiver on a telecommunication network and acquired by the signatory on a user station which has transmitted the data to be transmitted. Thanks to these arrangements, the user of the user station is authenticated by the fact that he has simultaneously a receiver on the telecommunication network.

According to particular characteristics of each of the aspects of the present invention, the process comprises an operation of substituting a signature in the course of which a private key of the signature is associated with the data to be transmitted. Thanks to these arrangements, the private key of a user can be saved in a secure place, on a secured server, such that no user station used by the emitter of data to be transmitted need save said private key. The private key is thus particularly protected.

According to particular characteristics of each of the aspects of the present invention, the process comprises an operation of association of a date and hour with the transmitted data. Thanks to these arrangements, the transmission of the data is timed and dated.

According to particular characteristics of each of the aspects of the present invention, the disposable certificate is a certificate with a lifetime less than one hour. Thanks to these arrangements, the same certificate can be used only during a predetermined period.

The present invention also envisages a device for certification, characterized in that it comprises:

means for generating a disposable certificate;

means for receiving a disposable certificate;

means for encoding data with said disposable certificate;

means for transmitting encoded data;

means for signing the transmission of said data; and

means for revoking said disposable certificate.

According to one aspect of the present invention, the user or client identifies himself on a first communication support, for example the Internet, by supplying a certificate, for example according to the infrastructure with a public key PKI, and said certificate comprises the unique address of a terminal of said user on a second communication support, for example a mobile phone number of the user. According to particular characteristics, the unique address on the second support is encoded with a public key such that only certain accustomed entities or certain certification authorities can decode said unique address. According to particular characteristics, the certificate which comprises said unique address on the second communication support points toward, that is identifies or comprises, another certificate, for example according to the infrastructure with a public key PKI, which does not comprise said unique address.

Other advantages, objects and characteristics of the present invention will become apparent from the description which follows, given by way of explicatory and in no way limiting example, with respect to the accompanying drawings, in which:

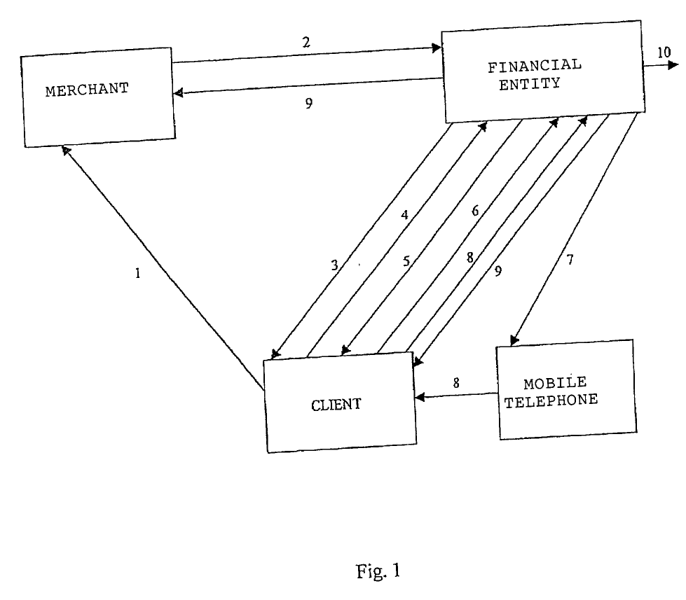

FIG. 1 shows transmissions of messages between entities taking part in a transaction, according to a first embodiment,

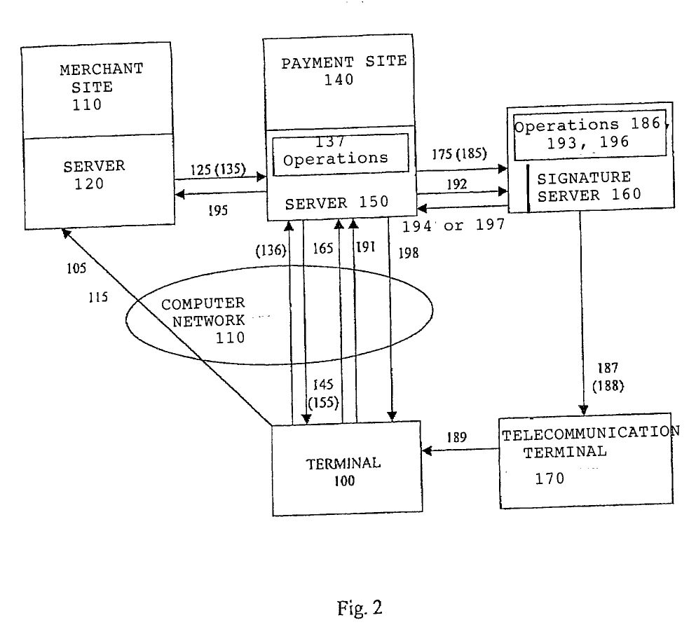

FIG. 2 represents transmissions of messages between entities participating in a transaction, according to a second embodiment,

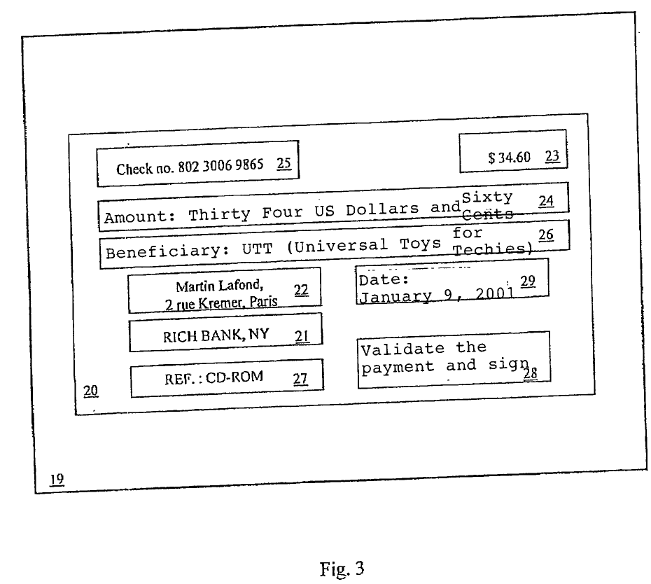

FIG. 3 represents an image of an electronic single usage payment means,

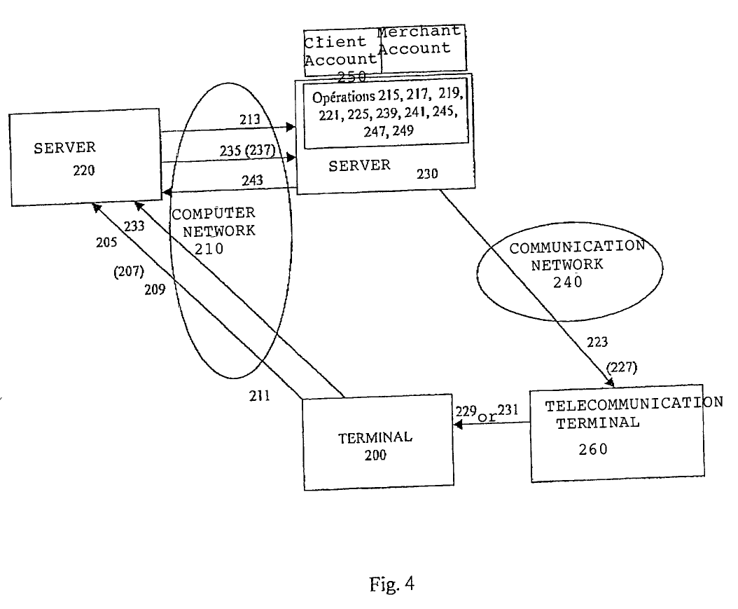

FIG. 4 represents transmissions of messages between entities taking part in a transaction, according to a third embodiment,

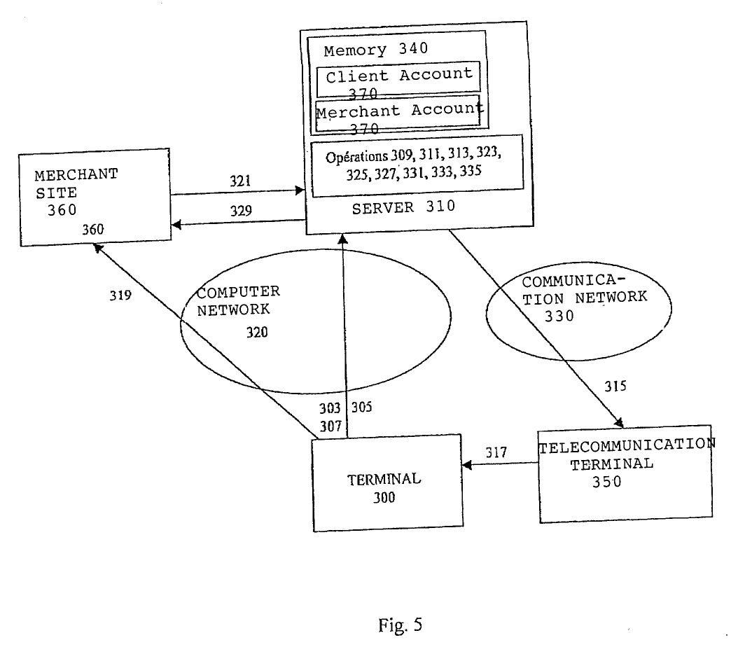

FIG. 5 represents transmissions of messages between entities taking part in a transaction, according to a fourth embodiment,

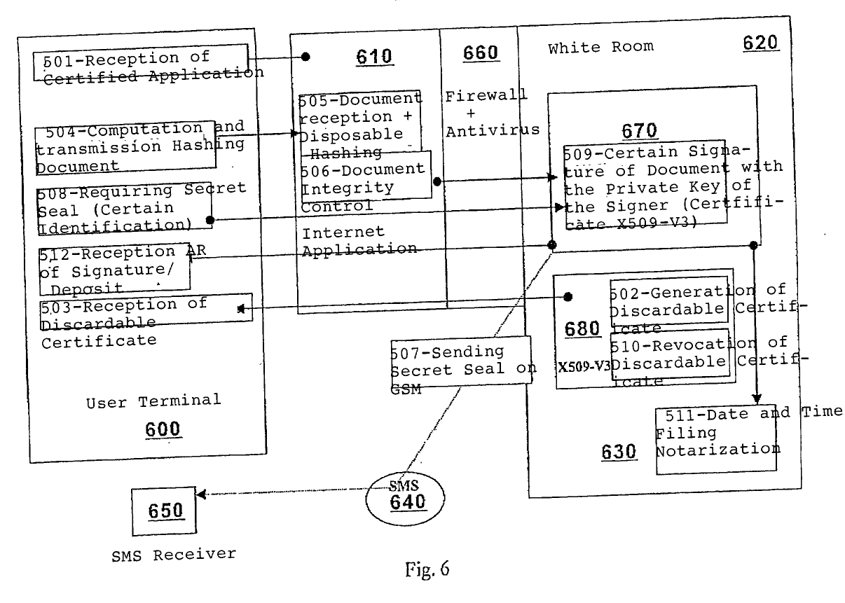

FIG. 6 represents a sequence of operations carried out by a user terminal and a certification server, in a particular embodiment of the present invention,

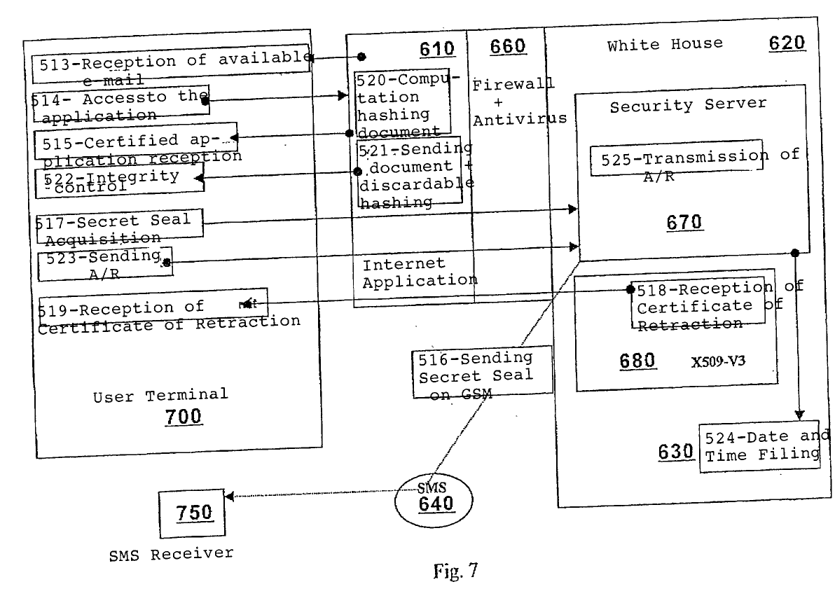

FIG. 7 represents a sequence of operations carried out by a user terminal and a certification server, in another particular embodiment of the present invention,

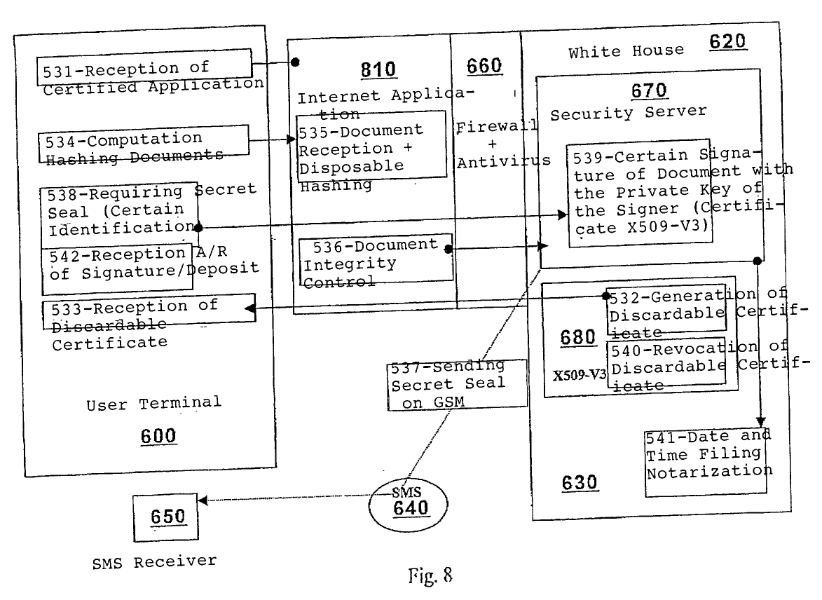

FIG. 8 represents a sequence of operations carried out by a user terminal and a certification server, in another particular embodiment of the present invention, and

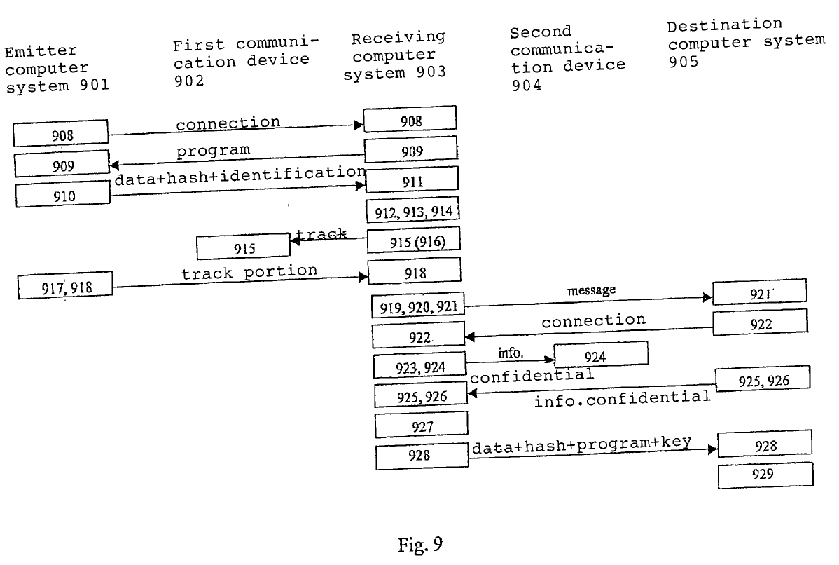

FIG. 9 represents an organogram of the use of another embodiment of the present invention.

In all the description, the term “unique address terminal” indicates a terminal on a communication network whose address cannot be attributed to another terminal. For example, a telephone or a pager is a unique address terminal.

In the transaction diagram shown in FIG. 1, the client is inscribed and has an account at a financial organization which uses a payment server adapted to determine a terminal address on a communication support in which each address is attributed to at most one terminal. This account permits him to have a confidential data preservation file known as a “server side wallet”. In this file are stored data relative to the mode of payment that the client has and particularly relative to an electronic checking account.

The financial organism is of the “issuer” type, which is to say it emits means of payment, here of single use, or it is an intermediate having made agreement with “issuer” banks.

The merchant has an agreement with the financial organism “issuer” and has an open account which is not necessarily a substitute for his conventional bank account in his so-called “acquirer” bank, because it receives the payments for the account of the merchant.

The merchant presents, on the payment page of his site, an icon proposing to his clients to pay by means of a payment means called “payment means with single electronic usage”. It will be noted that this icon can be that of a bank or of a type of bank card.

In FIG. 1 are shown the steps according to the process of the present invention:

1. The client decides to pay for articles which he has selected and referenced in his basket (known in France by the name “caddy”, trademark and in English by the name “shopping cart”). Let it be supposed in what follows of the description, that the client selects as payment mode the “electronic single use payment means” provided by the merchant. It will be noted that this choice can be carried out by selecting a bank icon or an icon representing a checkbook or a check, for example.

2. The merchant sends the processing of this request to the financial organization (or intermediary) which proposes this payment service by means of payment by electronic single use. In these exemplary embodiments, the client deals directly with the site of the financial institution.

3. The financial institute demands of the client to identify himself to have access to the electronic check service.

4. The client identifies himself. In the exemplary embodiments, the client gives his name, his given name, a user name and/or a password known only to him.

5. The financial entity presents to the client the electronic single use payment means filled in with the elements corresponding to the transaction (name of merchant, amount, time and date, . . . ) for acceptance and electronic signature. In exemplary embodiments, the single use payment means is represented in the form of a check on a screen of the client's terminal.

6. The client validates his acceptance. In the exemplary embodiments, the client selects with a pointer such as a mouse, a “payment validation” button.

7. The financial entity calculates an electronic signature, or seal, which is to say a sequence of unpredictable symbols and sends a certificate connected to the transaction and containing this sequence, via a mobile telephone network, such as the GSM network, to the mobile phone of the client. In exemplary embodiments, the signature or seal is transmitted in the form of a short message known as an “SMS”.

8. The client authenticates and signs the electronic single use payment means by reacquiring the electronic signature of the certificate on the keyboard of his consultation station (or terminal) connected to the Internet network (electronic signature principle).

9. The financial entity returns the confirmation of the payment to the client and to the merchant so that the latter can deliver the purchased products.

10. The financial organism processes the transaction by transmitting the information to the bank compensation network so that the amount of the transaction will be credited to the account of the merchant in his “acquirer” bank.

According to a particular embodiment, a user of a first communication terminal connected to a communication network, such as a personal computer connected to the Internet, opens a communication session with a merchant site. During the communication session, the merchant site proposes payment by electronic single use payment means and, in the case of acceptance by the client, the merchant site or the first terminal opens a second communication session with a supplier site by means of electronic single usage payment or the terminal emits an electronic single usage payment means.

To this end, in a window of the first terminal, a window which represents the single use payment means comprises one, several or preferably all the following fields:

a name associated with a merchant site,

an amount of payment,

a name associated with the user,

an account number attributed to the user,

a payer entity name,

time stamping, and

a region where the user is to supply said confidential information.

To carry out the payment, confidential information is communicated to the user, by means of a second communication support, such as a mobile phone network or a network for the transmission of alphanumerical messages.

The user thus acquires the confidential information on the first terminal and the first terminal transmits this confidential information to the merchant site.

After verification of correspondence of the confidential information received on the part of the first terminal on the second communication network with the confidential information transmitted to the second user terminal, the payment is validated.

Preferably, the process comprises a transmission operation, by the merchant site, of a demand to emit a payment certificate to a third party site. Preferably, the third party site transmits an amount available in the account attributed to the user. Preferably, the process comprises an operation of allocation of a certificate of integrity to the assembly constituted by the single use payment means and the confidential information acquired by the user.

In the particular embodiment shown in FIG. 2, a client accesses, by means of a terminal 100 and a computer network 110, for example the Internet, a merchant site 120, housed by a network server 130 (operation 105). The client identifies himself by giving his name, given name and address or by transmission, by the terminal 100, of a unique certificate delivered to the client, for example a certificate connected to the infrastructure with a public key PKI. To pay, let it be supposed in what follows of the description of FIG. 2 that the client selects a payment option by means of an electronic single usage payment proposed by the merchant site 120 (operation 115). It will be noted that the merchant site 120 can propose only this option, because, in distinction from payments by bank card without a signature, the client cannot repudiate a payment made with signature or authentication.

The network server 130 then transfers the client to a payment site 120 housed by a network server 150, or a payment server (operation 125). In the preferred exemplary embodiments, the network server 130 or the merchant site 120 transmits to the network server 150 of the payment site 140 information representative of the identity of the merchant, of the bank references of the merchant, of the identity of the client, of a unique certificate delivered to the client in accordance with the infrastructure with public key infrastructure PKI, of the amount of the transaction, of the time and date and/or the goods or services concerned with the transaction (operation 135). In exemplary embodiments, the client supplies all or a part of this information to the server 150 by means of the terminal 100, for example by transmission of a single certificate delivered to the client in accordance with the PKI or by acquisition with the keyboard (operation 136).

The payment server 150 determines whether the payment can be authorized, for example as a function of the identity of the client, of the amount of the payment, of the condition of the financial account or bank account of the client, according to known procedures (operation 137). If the payment can be authorized, the server 150 of the payment site 140 transmits information, for example an image, representative of electronic single use payment means, for example an image of a check, to the terminal 100 of the client (operation 145). In exemplary embodiments, this electronic single use payment means is already partially or completely prefilled, with all or a portion of the information transmitted in the course of operation 135 (operation 155).

The client validates or not the payment by selecting or not a validation button connected to the information received by the terminal 100 in the course of operation 145 (operation 165). When the client validates the payment, the network server 150 of the payment site 140 transmits to a signature server 160 information identifying the client (operation 175). In exemplary embodiments, the server 150 transmits to the signature server information relative to the payment, for example the object of the payment, the amount of the payment, the time and date and/or the name of the merchant. The signature server 160 searches in a database or in a correspondence table, for a unique address of a telecommunication terminal 170 connected to the client, for example a mobile phone number on a mobile telephone network (operation 185).

The signature server 160 then determines a single usage seal, in the form of a sequence of symbols (operation 186). In exemplary embodiments, the seal depends on at least one element of the transaction, for example the amount, the identity of the merchant, the identity of the client, a unique certificate delivered to the client, the time and date and/or object of the transaction. For example, the seal is determined as a mathematical function (for example a hash) of all or part of these elements. Preferably, the seal depends on the identity of the client and/or on a unique certificate delivered to the client (for example connected to the PKI).

The signature server 160 transmits to the telecommunication terminal 170 the single use seal (operation 187). In exemplary embodiments, the signature server 160 transmits to the telecommunication terminal 170 at least one element of the transaction, for example the amount, the identity of the merchant, the identity of the client, the time and date and/or the object of the transaction in addition to the seal (operation 188).

To validate the payment, the client reads the seal on a screen of the terminal 170 or listens to the symbol sequence dictated by a vocal server on a loudspeaker of the terminal 170, then acquires the seal on the terminal 100, for example on the keyboard or by vocal dictation (operation 189). In modifications, the client connects the terminal 170 to the terminal 100 so that the transmission of the seal will take place automatically.

The seal is transmitted by the terminal 100 to the network server 150 (operation 191). The server 150 transmits the seal to the signature server 160 (operation 192). The signature server verifies the seal (operation 193) and, in case of correspondence between the seal emitted in the course of operation 187 and the seal received in the course of operation 192, the signature server 160 transmits information validating the signature to the server 150 (operation 194). The server 150 transmits information validating payment to the network server 130 (operation 195). The signature server invalidates the seal for any other payment (operation 196).

In the case of absence of correspondence between the seal emitted in the course of operation 187 and the seal received in the course of operation 192, the signature server 160 transmits default information as to the signature to the server 150 (operation 197) and the server 150 informs the client of the signature default and again asks him to supply the seal (198) and the operation 191 and the following repeat. After three times, which is to say three operations 197, the signature server invalidates the seal and the payment server 150 transmits information as to the absence of payment to the server 130.

Although in the description of FIG. 2, the servers 130, 150 and 160 have been shown as separated, in exemplary embodiments at least two of the servers 130, 150 and 160 can be merged.

Preferably, the operations 125 and the following ones take place entirely in the course of the same communication session between the terminal 100 and the server 150. Preferably, this communication session is secured, for example encoded according to encryption standard SSL.

In FIG. 3 is shown an image of an electronic single use payment means, as can be displayed on a screen 19 of a terminal accessible to a client. This image 20 resembles that of a check comprising the information zones:

a zone 21 indicating the coordinates of the emitting entity,

a zone 22 indicating the coordinates of the client,

a zone 23 indicating the amount of payment, in numbers,

a zone 24 indicating the amount of payment, in letters,

a zone 25 indicating a number of payment means,

a zone 26 indicating the coordinates of the merchant,

if desired, a reference zone 27 in which is indicated the object of the transaction,

a signature zone 28, which here takes the form of a “validate payment and sign” button, and

a time and dating zone 29, comprising a date, and if desired, the time of the transaction.

All or a part of the zones 21 to 27 and 29 are automatically filled as a function of information supplied by a merchant site server and/or a payment server, so that the client has only to verify the information carried by the electronic single use payment means and to validate the payment by first clicking on the button “validate payment and sign”, then by acquiring a seal which he receives on a unique address communication support, for example a mobile telephone network.

Preferably, the image of the single use payment means is automatically preserved in a non-volatile memory of the client's terminal.

According to one aspect of the present invention, an electronic single use payment means is associated with a recapitulation of transaction elements comprising at least the amount of the transaction and preferably an identification of the merchant.

In the particular embodiment shown in FIG. 4, a client terminal 200 accesses, by means of a first communication network 210, for example the Internet, a merchant site server 220 (operation 205).

Preferably, the communication between the terminal 200 and the server 220 passes in a secured communication mode, for example encoded (operation 207) before the user enters a payment zone of the merchant site.

The terminal 200 supplies to the server 220 an identification of the user of the terminal 200, for example his name, given name and address, a subscriber name with or without a password, a cookie, a slip placed by the merchant site on the terminal 200 (operation 209) or a unique certificate delivered to the user of the terminal 200 according to the PKI.

The client triggers the operations of payment by selecting a payment function on a page of said site, for example by clicking on a button (operation 211). Whilst preserving, until the end of the payment operations, the communication session opens with the terminal 200 connected to the first communication means 210, the server 220 of the merchant site supplies, for example on the first communication network, an identification of the client to a payment server 230, preferably with an identification of the merchant site, and an amount of payment (operation 213). The payment server 230 determines an address on the second communication network 240, preferably with unique addresses, for example a telephone network, for example mobile (operation 215).

The payment server 230 determines a number of the single use payment means (operation 217) of which it preserves in a memory (operation 219) the relation with the account 220 of the client, for example the account of the credit card or a bank account. In exemplary embodiments, the number of the single use payment means depends on the identity of the client and/or on the elements of the transaction, for example the amount, the time and date or the identity of the merchant.

In exemplary embodiments, the number of the single use payment means is selected from among an assembly of numbers similar to the numbers of an embossed payment card.

The payment server 230 determines whether the payment is authorized, for example as a function of the amount of the payment and of authorization information as to payment associated with the account 250 (operation 221). The payment server 230 transmits the number of the single use payment means to a terminal 260 connected to the second communication network 240 which possesses said address on the second communication network, for example by a short message (operation 223). If desired, the payment server 230 determines a maximum duration of validity of the single use payment means number (operation 225). If desired, the payment server transmits to the terminal 260 on the second communication network 240, the amount of the payment and/or an identification of the merchant site (operation 227). The terminal 260 receives the transmitted information and retransmits it to the terminal 200, by an electronic connection (operation 229) between the terminals 260 and 200 or, preferably, by manually recopying carried out by the user of the terminals 200 and 260 in a window of a merchant site page provided for this purpose (operation 231), the single use payment number. The terminal 200 transmits to the server 220 the single use payment means number (the number of the single use payment means) (operation 233).

In exemplary embodiments, the number of the single use payment takes the form of the number of a payment card of known type and the user uses the single use payment number as a payment card number embossed on a payment card of plastic material.

The server 220 of the merchant site transmits the number of the single use payment means to the payment server 230 (operation 235). The server of the merchant site 220 transmits if desired a payment amount, an identification of the merchant site and/or an identification of the merchant account, in particular the information which has not already been transmitted to the payment server 230 (operation 237). The payment server 230 verifies the correspondence between the number of the single use payment means which the payment server 230 has transmitted to said address on the second communication network and the number of the single use payment means that the payment server receives from the merchant site server (operation 239). In the case of correspondence and if the number of the single use payment means is still valid (test 241), the payment server 230 emits information authorizing payment to the server 220 of the merchant site (operation 243), resulting in the payment, if desired deferred, from the client account to the merchant account, by modifying the data held in the memory with respect to the client account (operation 245) and by giving rise to the modification of the data held in memory as to the merchant account (operation 247), and invalidates a new use of the same number of the single use payment means with respect to the bank accounts or credit of the user (operation 249).

In a particular embodiment shown in FIG. 5, a user terminal 300 accesses a payment server 310 on a first communication network 320, for example the Internet (operation 303) and interrogates a payment server 310 for a number of a single use payment means, in the course of a communication session on a first communication network 320 (operation 305). The terminal 300 transmits to the payment server 310 an identification of the user, for example whose name, given name and address, a subscriber name with or without a password, a cookie, a slip placed by the payment server 310 on the terminal 300 or a unique certificate delivered to the client according to the PKI (operation 307).

The payment server 310 determines an address on a second communication network 330, preferably with unique addresses, for example a telephone network, for example mobile (operation 309). The payment server 310 also determines a number of a single use payment means whose payment means saves in its memory 340 the relationship with an account of the client, for example a credit card account or a bank account (operation 311). The payment server 310 determines a duration of use of the single use payment means (operation 313). In exemplary embodiments, the number of the payment means is selected from a group of available numbers similar to the numbers of embossed payment cards.

The payment server 310 transmits the number of the single use payment means to a terminal 350 connected to the second communication network 330 which possesses said address on the second communication network 330, for example by a short message (operation 315). The user receives the transmitted information (operation 317) and uses this single use payment means to pay for a purchase at a merchant site 360 (operation 319), in a manner known per se, for example by introducing into spaces provided to receive numbers of bank cards. The server of the merchant site 360 transmits the number of the single use payment means to the payment server 310 with an amount of payment, an identification of the merchant site and/or an identification of the merchant account (operation 321).

The payment server 310 verifies the correspondence between the number of the single use payment means which it has transmitted to the terminal 350 and the number of the single use payment means that the payment server 310 receives from the merchant site server 360 (test 323) and, in case of correspondence, verifies that the maximum duration of use of the single use payment means is not exceeded (operation 325) and determines whether the payment is authorized, for example as a function of the amount of payment to be carried out and of information associated with the client's account 370 (test 327). If the payment is authorized and if the duration of use is not exceeded, the payment server 310 emits authorization of payment information to the server 360 of the merchant site (operation 329), causes the payment, if desired deferred, from the client account to the merchant account, by modifying the data preserved in the memory in relation to the client account (operation 331) and by carrying out the modification of the data preserved in the memory of the merchant account 380 (operation 333), and invalidates a new use of the same number of the single use payment means in relation to the bank or credit accounts of the user (operation 335).

In FIG. 6 are shown a user station or emitter computer system 600, an Internet application 610, a white room 620, a storage memory 630, a second communication network 640 and a receiver 650 on the second communication network 640. The white room 620 comprises a firewall 660, a security server 660 and a certificate generator 680. The operation carried out in this particular embodiment shown in FIG. 6 are shown in rectangles and designated 501 to 512. The Internet application 610 and the white room 620 are conjointly called a receiver computer system.

The user station 600 is for example a personal computer (PC), a network computer (NC) or a personal digital assistant (PDA) or any terminal permitting remote communication, interactive terminal, TD decoder, . . . The user station 600 is provided with remote communication software to use the Internet application 610, conjointly with the security server 670. This remote communication software can be navigation software or electronic courie software, for example.

The Internet application 610 permits communication between the user station 600 and the security server 670 and the transmission of data from the user station 600 to the storage member 630, for example by means of the security server 670. The white room 620 is a space protected against any physical intrusion, such as a bank vault. The storage memory 630 is a memory adapted to preserve data for a long period, which exceeds one year.

The second communication network 640 is for example a telephone network and, again more particularly a mobile telephone network or alphanumerical receivers commonly called “pagers”. The second network 640 is called “second” by comparison with the Internet network, which is also called the “first” network in what follows of the present application. The second network 640 is adapted to transmit a key, a seal, a hash or a certificate from the security server 670 to the receiver 650. The receiver 650 in the second network 640 can, according to the type of the second network 640, be a mobile phone, a pager or any receiver. The receiver 650 permits the user of a user station 600 to take account of information transmitted by the security server 670.

The firewall 660 is of the material and/or software type and prevents any software intrusion into the security server 670. The security server 670 is a computer server of known type. Finally, the certificate generator 680 is adapted to generate disposable certificates, for example of the type according to the PKI, for example according to the standard X509-V3.

The user station 600 and the security server 670 are conjointly adapted to use the operations indicated below. For example, the security server 670 is adapted to supply application routines or “applets” to the user station 600.

At the beginning of the certification process, let is to be supposed that data are to be transmitted in a certified and signed manner from the user station 600 to the storage memory 630. The user of the user station 600 connects to the security server 620 to begin the certification process.

In the course of operation 501, after identification of the user at the user station 600, the Internet application 610 telecharges a certified and signed application routine in the user station 600. It will be noted that the application routine in question can be telecharged only in the case in which a copy of this routine has not already been implanted in the user station 600. This particular characteristic permits rendering portable the certification process of the present invention, without slowing this process in the case in which the user successively uses the same user station 600, for several certifications of data. In the course of operation 502, the certificate generator 680 generates a disposable certificate, for example in the form of a private key according to PKI, for example according to the standard X509-V3. For example, the disposable certificate is generated at random by the generator 680.

In the course of operation 503, the security server 670 transmits the disposable certificate to the user station 600. In the course of operation 504, the user station 600 uses the applicative routine telecharged in the course of operation 501 to obtain a track of the data to be transmitted, called a hash, which track depends on the disposable certificate generated in the course of operation 502 and on the data to be transmitted and which permits the detection of any ultimate modification of the data to be transmitted.

In the course of operation 505, the data to be transmitted and the hash are teleloaded from the user station 600 to the Internet application 610. Moreover, the coordinates for each destination of the data to be transmitted are transmitted by the user station 600 to the Internet application 610. These coordinates can take the form of an electronic courier address or “e-mail”, of a telephone number or any other type of information permitting contacting each destination for the data to be transmitted. In the course of operation 506, the integrity of the data to be transmitted is verified, by using the disposable key generated in the course of operation 502 and the hash.

It will be noted that at the end of operation 506, a copy of the data to be transmitted has been made from the user station 600 in the Internet application 610 and that this copy is certified to correspond to the original thanks to the use of a disposable key. To avoid the disposable certificate being reused, in the course of operation 510, the disposable certificate is revoked, which is to say that it becomes unusable to certify data.

As a modification, the disposable certificate generated in the course of operation 502 is a certificate of very short lifetime, preferably less than one hour. In this modification, operation 510 is not executed because beyond the duration of the lifetime of the disposable certificate, this certificate is not usable to certify data.

Operations 507 and 508 correspond to an example of signature that can be used in combination with operations 501 to 506 above. In the course of operation 507, a secret seal is generated and transmitted by means of the second network 640, to the receiver 650. The address of the receiver 650 on the second network is determined by placing in correspondence the identification of the user transmitted in the course of operation 501, with said address, in a correspondence table. Preferably, the secret seal is calculated on the signature elements of the document. Preferably, the secret seal depends on the data to be transmitted, their number, their content, their date and hour of generation of the secret seal, on the private key of the emitter of the data determined in correspondence with the identification of the user transmitted in the course of operation 501, on the Internet address (“IP address”) of the user station 600 and/or on a number of an Internet session in the course of which the data are transmitted. According to an example of the practice of operation 507, the secret seal is obtained by computing the hash of the data to be transmitted, for example in the form of a sequence of 20 symbols, numbering this hash by the private key of the user of the user station 600, and extracting a portion of the result of this numbering, for example eight symbols out of 20.

Preferably, at least one coordinate of at least one destination of the data to be transmitted, is transmitted with the secret seal, in the course of operation 507, such that the emitting user can identify the message which he is about to sign.

The reader could refer to FIG. 9 and/or to patent application PCT/FR 98/02348, incorporated herein by reference, for a better understanding of examples of steps of practice of operations 507 and 508. In the course of operation 508, the common user of the user station 600 and of the receiver 650 acquires the secret seal and this secret seal is transmitted to the security server 670 where the seal is verified, operation 509.

As a modification, operations 507 to 509 are replaced by a signature operation based on the use of a memory card (“smart card”) or a biometric measurement or any other supposedly reliable means of authentication of the user.

At the end of operation 508, the transmitted data are thus certified as valid and signed by the user who transmits them. The operation 509 consists in substituting a PKI signature, namely infrastructure of a public key, for the signature carried out in the course of operations 507 and 508.

In the course of operation 509, the transmitted data are signed with a private key of the user who transmits them (so-called “signature” of the data).

Finally, in the course of operation 511, the transmitted data, certified and signed by the private key, are transmitted to the storage memory 630 with a data and if desired an hour in such manner that they are time dated, filed and notarized.

In an application of the present invention to the personal delivery of transmitted data, an addressee is, at the end of operation 511, alerted to the availability of the data to be transmitted and operations similar to the operations set forth are practiced to provide a certified copy at the user station of the addressee after having collected for his part a signature. For example, a signature as set forth in patent application PCT/FR 98/02348 can, again be used to authenticate the addressee. An example of a series of operations used for this personal delivery is given in FIG. 7.

In FIG. 7 are shown a destination user system or destination computer system 700, the Internet application 610, the white room 620, the storage memory 630, the second communication network 640 and a receiver 750 in the second communication network 640. The operations carried out in the particular embodiment shown in FIG. 7 are shown in rectangles and numbered 513 to 525. These operations can follow the operations 501 to 512 shown in FIG. 6 and carried out in relation to a user station 600 generally different from the user station 700.

The destination user station 700 is for example a personal computer (PC), a network computer (NC) or a personal digital assistant (PDA). The destination user station 700 is provided with remote communication software to use the Internet application 610, conjointly with the security server 670. This remote communication software can be navigation software or electronic courier software, for example.

The Internet application 610 permits communication between the user station 700 and the security server 670 and the transmission of data from the user station 700 to the storage memory 630, for example by means of a security server 670.

The receiver 750 in the second network 640 can, according to the type of second network 640, be a mobile phone, a pager or any receiver. The receiver 750 permits the user of the destination user station 700 to take account of information transmitted by the security server 670.

The destination user station 700 and the security server 670 are conjointly adapted to use operations indicated below. For example, the security server 670 is adapted to supply applications routines or “applets” to the destination user station 700.

At the beginning of the certification process, let it be supposed that the data are transmitted in a certified and signed manner from the storage memory 630 to the destination user station 700.

The user of the destination user station 700 connects initially to the first network, for example to consult electronic couriers.

In the course of operation 513, the Internet application 610 emits to the destination of the destination user station 700 an electronic courier (e-mail) which indicates that the information is at the disposal of the user of the station 700. In exemplary embodiments, at least one coordinate of the emitter user is transmitted in this electronic courier so that the destination can identify the emitting user.

In the course of operation 514, the user accesses the internal application 610 by selecting his Internet address. In the course of operation 515, the Internet application 610 teleloads a certified application routine into the destination user station 700. It will be observed that the applicative routine in question can be teleloaded only in the case in which a copy of this routine has not already been implanted in the user station 700. This particular characteristic permits rendering portable the certification process according to the present invention, without slowing this process in the case in which the user successively uses the same destination user station 700, to receive several data assemblies. It will be noted that the applicative routines teleloaded in the course of operations 501 and 515 can be identical to permit on the one hand the transmission of data to the memory 630 and, on the other hand, to receive data from this memory.

The operations 516 and 517 correspond to an example of signature that can be used in combination with operations 513 to 515 above. In the course of operation 516, a secret seal is generated and transmitted, by means of the second network 640, to the receiver 750. Preferably, the secret seal is calculated on the signature elements of the document. Preferably, the secret seal depends on the data to be transmitted, their number, their content, the date and time of generation of the seal, and/or a number of the Internet session in the course of which the data are transmitted.

In exemplary embodiments, at least one coordinate of the emitter user of the data to be transmitted is transmitted with the secret seal, in the course of operation 516, such that the destination user can identify the emitting user.

The reading can be in accordance with patent PCT/FR 98/02348 to better understand the examples of the steps of use in the course of operations 516 and 517. In the course of operation 517, the common user of the destination user station 700 and of the receiver 750 acquires the secret seal on the destination user station 700 and this secret seal is transmitted to the security server 670 where the seal is verified. At the end of operation 517, the transmitted data are thus certified to be valid and signed, by the user who transmits them.

As a modification, operations 516 and 517 are replaced by a signature operation based on the use of a memory card (“smart card”) or a biometric measurement.

In the course of operation 518, the certificate generator 680 generates a withdrawal certificate, for example in the form of a key according to the PKI, for example according to the standard X509-V3. The withdrawal certificate contains the public key of the user of the user station 600. In the course of operation 519, the security server 670 transmits the withdrawal certificate to the destination user station 700. In the course of operation 520, the application 610 determines the hash of the data to be transmitted, which depends on the withdrawal certificate generated in the course of operation 518 and on the data to be transmitted and which permits the detection of any ultimate modification of the data to be transmitted.

In the course of operation 521, the data to be transmitted and the hash are teleloaded from Internet application 610 to a destination user station 700. In the course of operation 522, the integrity of the data to be transmitted is verified, by using the public key contained in the certificate of withdrawal generated in the course of operation 518 and the hash.

It will be observed that at the end of operation 522, a copy of the data to be transmitted has been made from the storage memory 630 to the destination user station 700 and that this copy is certified to conform to the original thanks to the use of a disposable key. In the course of operation 523, receipt of the certification of integrity is transmitted from the destination user terminal 700 to the security server 670. This acknowledgement of integrity verifies that the data to be transmitted have been transmitted to the destination user terminal 700 in an accurate manner, which is to say that the data to be transmitted have not been modified after operation 520.

In the course of operation 524, a track of the transmission of the data to the destination user is certified and memorized in the storage memory 630. This date and if desired time is associated with the transmitted data and is thus time dated, filed and notarized. In the course of operation 525, the security server places at the disposition of the transmitted data emitter a receipt which advises that the data that it transmits in the course of operation 504 have been received by one of their destinations. It will be noted that a receipt is transmitted to the emitter of the data for each of the destinations of the data.

In FIG. 8 are shown the user station or emitter computer system 600, an Internet application 810, the white room 620, the storage memory 630, the second communication network 640 and a receiver 650 in the second communication network 640. The operations carried out in the particular embodiment shown in FIG. 8 are represented by rectangles and numbered 531 to 542. The Internet application 810 and the white room 620 are conjointly called the receiver computer system.

The user station 600 and the security server 670 are conjointly adapted to practice operations 531 to 542 indicated below. At the beginning of the certification process, let it be supposed that several groups of data are to be transmitted in a certified and signed manner from the user station 600 to the storage memory 630. The user of user station 600 connects to the security server 620 to start the certification process.

In the course of operation 531, after identification of the user of the user station 600, the Internet application 810 teleloads a certified application routine into the user station 600. It will be noted that the applicative routine in question can be teleloaded only in the case in which a copy of this routine has not already been implanted in the user station 600. This particular characteristic permits rendering portable the certification process of the present invention, without slowing this process in the case in which the user uses successively the same user station 600, for several certifications of data. In the course of operation 532, the certificate generator 680 generates a disposable certificate, for example in the form of a private key according to PKI, for example according to the standard X509-V3. For example, the disposable certificate is generated randomly by the generator 680.

In the course of operation 533, the security server 670 transmits the disposable certificate to the user station 600. In the course of operation 534, the user explicitly selects each of the groups of data to be transmitted. For example, the user of user station 600 selects, one by one, the files to be transmitted, each file constituting a group of data to be transmitted.

Still in the course of operation 534, the user station 600 uses the applicative routine teleloaded in the course of operation 531 to obtain hash of each of the data groups to be transmitted, which depends on the disposable certificate generated in the course of operation 532 and on the data of said group. Each hash permits the detection of any ultimate modification of a group of data to be transmitted.

In the course of operation 535, the groups of data to be transmitted and the hash are teleloaded from the user station 600 to the Internet application 810. Moreover, coordinates of each destination of each group of data to be transmitted are transmitted by the user station 600 to the Internet application 610. These coordinates can take the form of an electronic courier address (“e-mail”), of a telephone number or of any other type of information permitting contacting each destination of the data to be transmitted. In the course of operation 536, the integrity of the groups of data to be transmitted is verified, by using the disposable key generated in the course of operation 532 and the hash.

It will be noted that at the end of operation 536, a copy of the groups of data to be transmitted has been made from the user station 600 in the Internet application 810 and that this copy of the groups of data is certified according to the original thanks to the use of a disposable key. To avoid the disposable certificate being reused, in the course of operation 540, the disposable certificate is revoked, which is to say that it becomes unusable to certify groups of data.

As a modification the disposable certificate generated in the course of operation 532 is a certificate with a very short lifetime, preferably less than one hour. In this modification, operation 510 is not executed because beyond the duration of the lifetime of the disposable certificate, this certificate is not usable to certify data.

Operations 537 and 538 correspond to an example of signature that can be used in combination with operations 531 to 536 above. In the course of operation 537, a secret seal is generated and transmitted, by means of the second network 640, to the receiver 650. The address of the receiver 650 in the second network is predetermined by placing in correspondence the identification of the user transmitted in the course of operation 531 with said address, in a correspondence table. Preferably, the secret seal depends on the data to be transmitted, their number, their content, and the data and time of generation of the secret seal, on the private key of the data emitter determined during correspondence with the identification of the user transmitted in the course of operation 531, on the Internet address (IP address) of the user station 600 and/or on a number of the Internet session in the course of which the data are transmitted. According to an example of practice of operation 537, this secret seal is obtained by computing the hash of the data to be transmitted, for example in the form of a sequence of 20 symbols, numbering this hash by the private key of the user of the user station 600, and extracting a portion of the result of this numbering.

Preferably, at least one coordinate of at least one destination of the data to be transmitted is transmitted with the secret seal, in the course of operation 537, such that the emitting user can identify the data to be transmitted which he is about to sign and at least one destination of these data.

The reader can refer to FIG. 9 and/or to patent application PCT/FR98/02348 for a better understanding of examples of the steps of the practice of operations 537 and 538. In the course of operation 538, the common user of the user station 600 and of the receiver 650 acquires the secret seal and the secret seal is transmitted to the security server 670 where the seal is verified, operation 539.

As a modification, operations 537 to 539 are replaced by a signature operation based on the use of a memory card (“smart card”) or on a biometric measurement.

At the end of operation 538, the groups of data transmitted are thus certified to be valid and signed by the user who transmits them. Operation 539 consists in substituting a so-called PKI signature for the signature performed in the course of operations 537 and 538.

In the course of operation 539, the groups of transmitted data are assigned with the private key of the user, who has transmitted them (so-called “signature” of the data).

Finally, in the course of operation 541, the groups of transmitted data, certified and signed by the private key, are transmitted to the storage memory 630 with a date and if desired a time, such that they are time dated, filed and notarized.

In an application of the present invention to the personal delivery of the groups of transmitted data, for each group of data to be transmitted, a destination is, at the end of operation 541, alerted to the availability of the groups of data to be transmitted and operations similar to the operations set forth above are practiced to make a certified copy at the user station of the destination after having obtained for his part a signature. An example of a sequence of operations used for this personal delivery is given in FIG. 7.

FIG. 9 shows an organogram of the practice of another embodiment of the present invention. In the leftmost column of FIG. 9 are shown the operations concerning a so-called “emitter” computer system 901 using a first communication support. In the column to the right of the leftmost column are shown operations concerning a first communication device 902 using a second communication support. In the central column are shown operations concerning a computer system 903 called a “receiver” using the first, the second, a third and a fourth communication support. In the rightmost column are shown operations relating to a computer system 905, called a “destination” using the third communication support. Finally, in the column between the central column and the rightmost column are shown operations concerning a second communication device 904 using the fourth communication support.

The emitter computer system 901 and the first communication device 902 are used by a user who desires to transmit data to a destination user who uses the second communication device 904 and the destination computer system 905. For example, the emitter computer system 901 is a personal computer, or a network computer, connected to the Internet.

For example, the destination computer system 905 is another personal computer, or another network computer, connected to the Internet. The first and third networks can be merged or separate. The first and third networks can thus be the Internet.

The second and fourth networks can, in particular, be wireless networks. For example, the first communication device 902 is a mobile phone or a pager. For example, the second communication device 904 is a mobile phone or a pager. The second and fourth networks can be the same or different. Moreover, the first and second communication supports are different. Furthermore, the third and fourth communication supports are different. Preferably, the communication devices 901 and 904 have unique addresses on the second and fourth communication networks, respectively.

According to one embodiment, the receiver computer system 903 is a network server connected at network interfaces to communicate with the first to fourth networks. In what follows of the description of FIG. 9, it will be considered that the receiver computer system 903 has means necessary to obtain:

a private key and a public key of a user of the emitter computer system 901,

the address of the first communication device 902 on the second communication support, and

the address of the second communication device 904 on the fourth communication support.

For example, the receiver computer system 903 preserves in its memory:

the private key and a public key of each user adapted to use the process described in FIG. 9,

a table of correspondence between the identifications of the users and the addresses on a second communication support, and

means for interrogating a database that has a table of correspondence between the identifications of the destination users and the addresses on the fourth communication support.

According to a modification, the address of the destination user on the fourth network is obtained by the emitter user, as in the case shown in FIG. 9.

The operations of starting and stopping the computer systems and the communication devices are not shown in FIG. 9.

In the course of an operation 908, the emitter computer system 901 is connected to the receiver computer system 903, by means of the first communication support. In the course of an operation 909, the receiver computer system 903 transmits to the emitter computer system 901 a program permitting determining a hash of the data to be transmitted.

In the course of transmission operations 910 and 911, the emitter computer system 901 transmits to the receiver computer system 903, on the first communication support:

data to be transmitted to the destination computer system 905,

a hash of the data to be transmitted determined with the transmitted program in the course of operation 909,

an identification of a utilizer of the emitter computer system 901 and an identification of the emitter computer system 901, and

an identification of the destination computer system 905 and an address of the second communication means 904.

In the course of an operation of placing in correspondence 912, the receiver computer system 903 places in correspondence said identification with a private key of the user of the emitter computer system 901.

In the course of a generation operation 913, the receiver computer system 903 generates a track of the data to be transmitted. The track is representative of the data to be transmitted. Preferably, said track is representative of a hash of said data to be transmitted and of the private key held by the receiver computer system 903. For example, said track is obtained by a signature operation of the hash by the private key of the user of the emitter computer system 901. Thus, said track is connected to said data and any ultimate modification of said data is detectable.

Moreover, the source of said data is thus authenticated by the private key of the user.

In the course of an operation of placing in correspondence 914, the identification of the user of the emitter computer system 901 is placed in correspondence with an address of the communication device 902 on the second communication support.

In the course of a transmission operation 915 of a portion of said track, at least a portion of the track determined in the course of the operation 913 is transmitted by the receiver computer system 903 to the first communication device 902. For example, the transmission operation 915 comprises in the course of the truncating operation 916 in the course of which the track determined in the course of operation 913 is truncated and the result of said truncation is transmitted to the first communication device 902.

In the course of a reception operation 917, said portion of the track is received by the emitter computer system 901. For example, the first communication device 902 display said track on a screen for visualization and the user of the first communication device 902 types said track on a keyboard of the emitter computer system 901. According to modifications, the emitter user dictates said portion of the track which is recognized by a voice recognition system or the emitter user supplies said portion of the track to the emitter computer system 901 by any user interface.

In the course of a transmission operation of said track portion 918, said track portion is transmitted from the emitter computer system 901 to the receiver computer system 903.

In the course of a verification operation 919, the receiver computer system verifies the correspondence of the track portion received by the receiver computer system 903 with the trace generated by the receiver computer system 903. The correspondence is, in the example of FIG. 9, an equality between the emitted track and the received track. If there is no correspondence, the receiver computer system indicates to the emitter user that it has not been authenticated by the first communication support or by the second communication support and invites the emitter user to begin again the operations illustrated in FIG. 9.

If there is correspondence, in, the course of an operation 920 of placing in correspondence, the receiver computer system 903 places in correspondence said data with a public key of the emitter user.

In the course of a communication operation 921, the receiver computer system 903 transmits a message, for example an electronic courier, to the destination user inviting him to connect by the third communication support to the receiver computer system 903. According to exemplary embodiments, an identification of the emitter user or of the computer system 901 is transmitted in said message.

In the course of a connection operation 922, the destination user carries out the connection between the destination computer system 905 and the receiver computer system 903.

In the course of an operation of generating confidential information 923, the receiver computer system 903 generates confidential information. In the course of a transmission operation 924, the receiver device 903 transmits said confidential information to the second communication device 904, by the second communication support. In the exemplary embodiments, an identification of the emitter user is transmitted with said confidential information.

In the course of a reception operation 925, said confidential information is received by the destination computer system 905. For example, the second communication device 904 displays said confidential information on a screen for visualization and the user of the second communication device 904 types said confidential information on a keyboard of the destination computer system 905. According to modifications, the destination user dictates said confidential information which is recognized by a voice recognition system, or the destination user supplies said confidential information to the destination computer system 905 by any user interface.

In the course of an operation of transmitting said confidential information 926, said confidential information is transmitted from the destination computer system 905 to the receiving computer system 903.

In the course of an operation of verifying correspondence 927, the receiver computer system 903 verifies the correspondence between the confidential information transmitted by the receiving computer system 903 and the confidential information received by the receiving computer system 903. If there is no correspondence, the receiving computer system 903 indicates to the destination user that it has not been authenticated, by the third or fourth communication support and invites him to repeat the operations 922 et seq.

When there is correspondence, in the course of a transmission operation of the data to the destination computer system 928, the receiving computer system 903 transmits to the destination computer system 905 the data to be transmitted. Preferably, the computer system 903 transmits conjointly with the data to be transmitted:

a public key of the emitter user to the destination computer system 905,

the track of said data to be transmitted calculated in the course of the operation, and

a program permitting determining said hash of said data.

In the course of an operation 929, the destination computer system determines the hash of said data to be transmitted calculated in the course of operation 913 and uses the public key received in the course of operation 928 to determine the hash of said data which has served to generate the track generated in the course of operation 928. When the two hashes are equal, the destination user has the assurance that it is the emitter user who has transmitted the data to be transmitted and that these data have not been modified since they were transmitted by the emitter user.

According to modifications, the operations shown in FIGS. 6, 7 or 8 and the operations shown in FIG. 9 are combined such that, according to these modifications, a disposable key is used for the transmission of the data from one computer system to another and a track which depends on the data to be transmitted and, if desired a private key of the emitter user, is operated.

According to one aspect of the present invention and in a modification of each of the embodiments set forth in the present specification, the user or client identifies himself, on the first communication support, for example the Internet, by supplying a certificate, for example according to the PKI, and said certificate comprises the unique address of a terminal of said user on the second communication support, for example a mobile phone number of the user. In these exemplary embodiments of this modification, the unique address on the second communication support is encoded with a public key such that only certain authorized entities or certain certification authorities can decode said unique address. In exemplary embodiments of this modification, the certificate which comprises said unique address on the second communication support leads to, which is to say identifies or comprises, another certificate, for example according to the PKI which does not comprise said unique address.

According to one aspect of the present invention and according to a modification of each of the embodiments described above, the signature by the retransmission of a confidential seal or of a hash gives rise to the conjoint emission of a key, for example according to the PKI.

It is to be noted that all the aspects of the present invention set forth in the present specification, and, in particular, with respect to the different figures, as well as all modifications and exemplary embodiments, can be combined if desired.

1. Process for payment comprising an operation of opening a communication session between a first user terminal and a merchant site server, on a first communication support, characterized in that it comprises, during said communication session:
an operation of transmission by the user terminal of information identifying the user,
an operation of transmitting to a payment server the information identifying the user,
an operation of constituting by said user terminal a single use payment certificate,
an operation of transmitting by the payment server of confidential information to a second user terminal, by means of a second communication support on which each address is attributed to at most one user terminal,
an operation of transmission by the first terminal of said confidential information;
an operation of verification, by the payment server, of the correspondence between the confidential information received from the first terminal on the first communication network with the confidential information transmitted to the second user terminal, and
in case of correspondence, an operation of validation of payment.

2. Process according to claim 1, characterized in that the operation of constitution comprises:
an operation of receiving the name of said merchant and the amount of payment; and
an operation of displaying in a window on a screen of the first user terminal, said window comprising the display of the name of the merchant site and of the amount of payment.

3. Process according to claim 2, characterized in that:
in the course of the reception operation, the name of the user is received and
in the course of the display operation, the name of the user is displayed in said window.

4. Process according to any one of claims 2 or 3, characterized in that:
in the course of the reception operation, an account number attribute to the user is received and
in the course of the display operation, the account number is displayed in said window.

5. Process according to any one of claims 2 to 4, characterized in that:
in the course of the reception operation, the name of a payer entity is received and
in the course of the display operation, the name of the payer entity is displayed in said window.

6. Process according to any one of claims 1 to 5, characterized in that it comprises an operation of transmission by the merchant site of a demand for emission of the payment certificate to a third party site.

7. Process according to any one of claims 1 to 6, characterized in that it comprises an operation of allocating a certificate of integrity to the payment certificate and to the confidential information acquired by the user.

8. Process according to any one of claims 1 to 7, characterized in that it comprises an operation of transmitting of an amount available in the account attributed to said user.
